(19) United States
(12) Patent Application Publication
(10) Pub. No.: US 2024/0180765 A1
(43) Pub. Date: Jun. 6, 2024

(54) BRAKE ASSEMBLY OF A TRANSPORTING MEANS FOR A PATIENT HANDLING APPARATUS

(71) Applicant: Arjo IP Holding Aktiebolag, Malmö (SE)

(72) Inventors: Olivier CUSTEAU-BOISCLAIR, Sherbrooke, Québec (CA); Martin FAUCHER, Georgeville, Québec (CA)

(73) Assignee: Arjo IP Holding Aktiebolag, Malmö (SE)

(21) Appl. No.: 18/285,666

(22) PCT Filed: Apr. 5, 2022
(86) PCT No.: PCT/SE2022/050340

§ 371 Date: Oct. 5, 2023

(30) Foreign Application Priority Data
Apr. 7, 2021 (SE) 2150430-3

(51) Int. Cl. A61G 7/05; B60B 33/02

(52) U.S. Cl. CPC A61G 7/0528; B60B 33/021; B60B 33/025; B60B 2200/26

(57) ABSTRACT

Brake assembly (18) of a transporting means (20) for a patient handling apparatus (10). The brake assembly (18) is adapted to control movements of a wheel (14a) of at least one rear caster (14) by a brake actuator (18a). The brake actuator (18a) is adapted to be coupled to a caster neck (14c) of said at least one rear caster (14). The caster neck (14c) extends through a lift base (11) of the patient handling apparatus (10) such that the brake actuator (18a) is located on top of the lift base (11) and the wheel (14a) of the rear caster (14) is located below the lift base (11).

### TECHNOLOGY FIELD

The present invention relates to a brake assembly of a transporting means for a patient handling apparatus. The present invention further relates to a transporting means comprising such brake assembly and to a patient handling apparatus comprising such transporting means comprising such brake assembly.

### BACKGROUND

Patient handling apparatuses such as lifts, also referred to as patient hoists and lifters, are commonly used to raise, lower and transfer patients who are disabled or who otherwise have mobility problems. There are several of different patient handling apparatuses and two common types of patient lifts are stanchion-mounted lifts, also known as floor lifts, and ceiling lifts. Floor lifts often have a hoist assembly or a lifting device, which may be disposed at the upper end of a stanchion, or a chair movably mounted to the stanchion. The stanchion has a wheeled base, which allows the lift to be wheeled to position the hoist assembly and lifting member over or adjacent to a patient. The wheeled base allows the lift to be moved along the ground to different locations. A ceiling lift may be utilized in a similar manner. However, in such lifts the hoist assembly is movably engaged to ceiling-mounted tracks such that the hoist assembly can be moved about the track from location to location.

Common applications for a patient handling apparatuses are to lift, lower and reposition patients. A further application is to transfer patients from one location to another, such as from a bed, a chair or other furniture to another location such as a bed, a chair or other furniture. In order to perform these tasks, the patient handling apparatus is moved adjacent to the patient. The lifting member is lowered to receive the patient and subsequently raised so that the patient may be wheeled to another location to be lowered and placed. It is crucial that each of the raising, lowering and transporting of the patient is performed in a safe way and is performed without exposing the patient, or the person helping the patient, i.e. the caregiver, to any risk.

In order to transport a patient from one location to another, patient handling apparatuses are generally provided with transporting means. The transporting means of floor lifts are typically realised by a wheeled base. However, even if a wheeled base is of great help when transporting a patient from one location to another, the transporting means may be associated with some risks when performing the lift and the lowering of the patient. It is important that the patient handling apparatus does not move during such occasions. Otherwise, the patient handling apparatus may move before the patient is securely received by or released from the patient handling apparatus. This may cause injuries both to the patient and to the caregiver as this may result in a sudden movement of the patient handling apparatus.

In order to prevent sudden and unexpected movements of patient handling apparatuses, brake assemblies have been developed for the transporting means of the patient handling apparatuses. However, none of the known brake assemblies provides a solution that is both functional and easy to access while still being safe to use together with the patient handling apparatus. Even if there are brake assemblies that may be easily accessible, none of the known solutions provides a solution that is accessible regardless of the position of the patient handling apparatus and its transporting means, i.e. that is easily accessible at all times.

Accordingly, there is a need for a safe and effective way to ensure that a patient handling apparatus only moves when it is supposed to and does not move when it is not supposed to. There is a need for a braking assembly that is easy for a user to access, while still providing a safe and functional solution.

In the light of the above, there is a need for an improved brake assembly for a transporting means for a patient handling apparatus that addresses the above mentioned challenges.

### SUMMARY

According to one aspect there is provided a brake assembly of a transporting means for a patient handling apparatus.

The brake assembly comprises a brake actuator, wherein the brake assembly is adapted to control movements of a wheel of at least one rear caster by activating the brake actuator. The brake actuator is coupled to a caster neck of said at least one rear caster. The caster neck extends through a lift base of the patient handling apparatus such that the brake actuator is located on top of the lift base and the wheel of the at least one rear caster is located below the lift base.

According to another aspect, there is provided transporting means for a patient handling apparatus. The transporting means comprises at least one rear caster coupled to a brake assembly.

According to still another aspect, there is provided a patient handling apparatus for handling a patient. The patient handling apparatus comprises a lifting device for lifting, raising and lowering a patient. The lifting device comprises a lift base with a frame, a boom and a patient support device. The patient support device is movable relative to the lift base. The patient handling apparatus further comprises transporting means for transporting the patient handling apparatus from one location to another location. Further, the transporting means comprises at least one rear caster and a brake assembly.

Further objects and features of the present invention will appear from the following detailed description of embodiments of the invention.

### BRIEF DESCRIPTION OF DRAWINGS

The invention will be described with reference to the accompanying drawings, in which:

FIG. 1 is a perspective view of a patient handling apparatus according to an embodiment;

FIG. 2a is a perspective view of a transporting means according to an embodiment;

FIG. 2b is a perspective view of a transporting means according to an embodiment;

FIG. 2c is a perspective view of a transporting means according to an embodiment;

FIG. 2d is a perspective view of a connection and relation between a caster and a brake assembly according to an embodiment;

FIG. 3a shows a side view of a rear caster according to an embodiment;

FIG. 3b illustrates a cross-section of a rear caster mounted to a patient handling apparatus according to an embodiment;

FIG. 4a shows a wheel of the transporting means according an embodiment.

FIG. 4b shows a brake element according to an embodiment;

FIG. 4c shows a connection and relation between a caster and a brake assembly according to an embodiment;

FIG. 4d shows a cross-section of a caster mounted to a patient handling apparatus according to an embodiment; and

FIG. 5 illustrates three modes of a brake actuator according to an embodiment.

### DETAILED DESCRIPTION

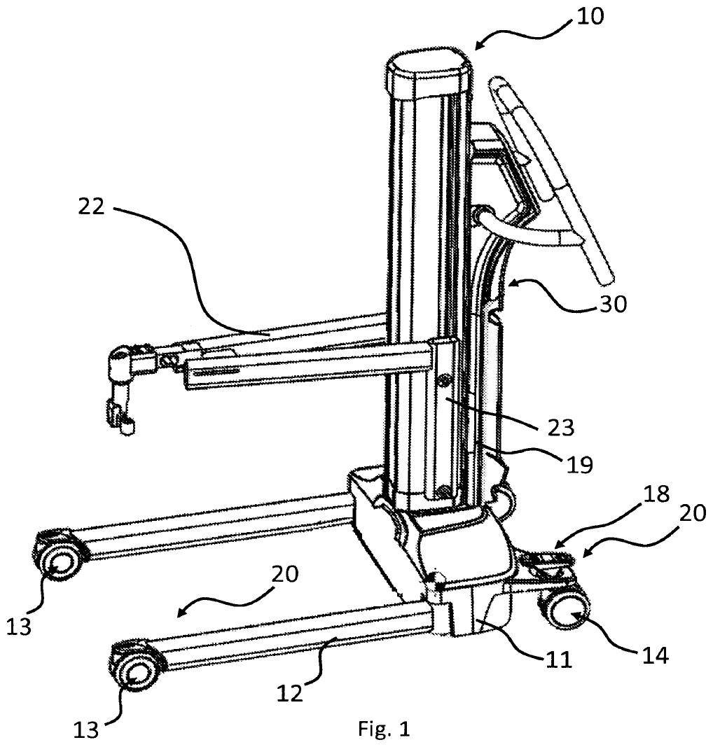

FIG. 1 shows an example of a patient handling apparatus 10 for handling a patient according to the present disclosure. The patient handling apparatus 10 comprises a lifting device 30 for lifting, raising and lowering a patient. The patient handling apparatus 10 further comprises transporting means 20 for transporting the patient handling apparatus 10, and possibly the patient, from one location to another. The transporting means 20 makes the patient handling apparatus 10 movable relative the ground. In FIG. 1, the transporting means 20 is coupled, or connected, to the patient handling apparatus 10. The transporting means 20 comprises a brake assembly 18. The brake assembly 18 is adapted to control the movements of the patient handling apparatus 10. The brake assembly 18 is adapted to control the movements by controlling the movements of a wheel of a caster 14 of the patient handling apparatus 10. The brake assembly 18 may prevent or allow rotation of the wheel of the caster 14 of the transporting means 20. Alternatively, the brake assembly 18 may control the movements of the patient handling apparatus 10 by allowing directional movement of patient handling apparatus 10, i.e. by allowing the wheel of the caster 14 to rotate but not to make any turns.

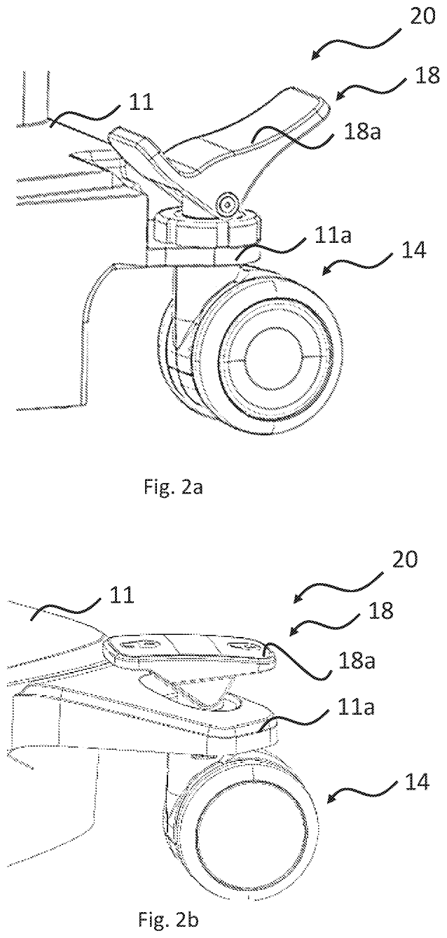

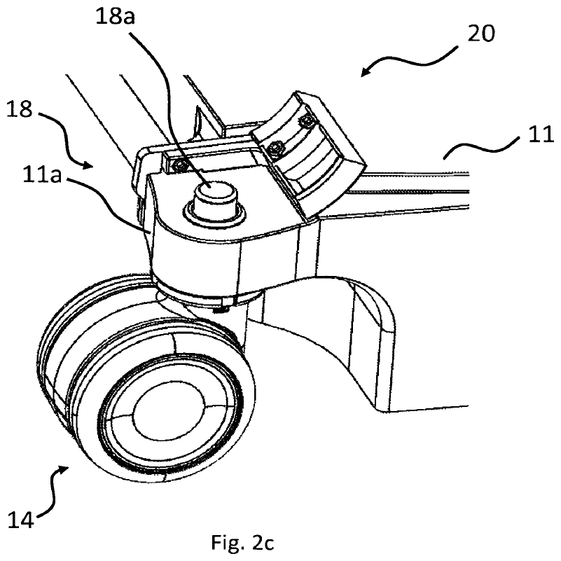

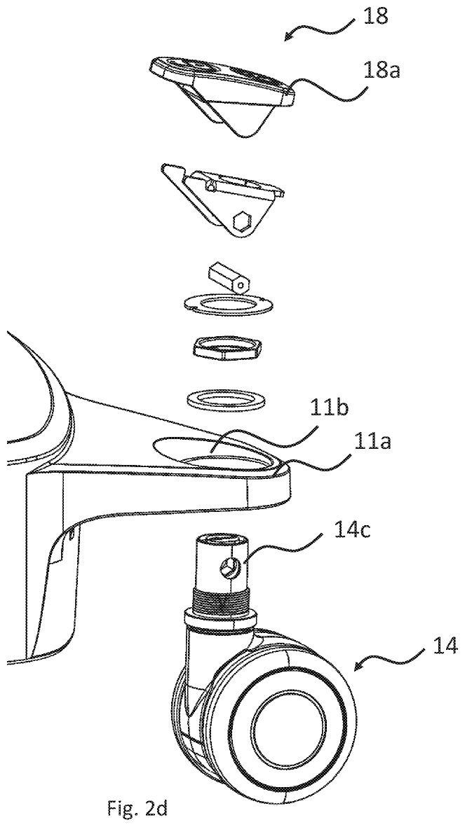

FIGS. 2a, 2b and 2c illustrate perspective views of brake assemblies 18 of transporting means 20 for patient handling apparatuses 10 according to the present disclosure. The transporting means 20 illustrated in FIGS. 2a, 2b and 2c comprise at least one caster 14. A caster 14 is a wheel on a rotating mount. As previously described, the transporting means 20 makes the patient handling apparatus 10 movable relative the ground, i.e. makes it possible for the patient handling apparatus 10 to be moved over a surface. In particular, it is the at least one caster 14, or the wheel of the caster 14, that is adapted to allow the movement of the transporting means 20, i.e. the patient handling apparatus 10, relative the ground. When a force is applied to the patient handling apparatus 10, the at least one caster 14 will start to move and transfer the patient handling apparatus 10 in collaboration with the applied force.

In preferred embodiments, the at least one caster 14 may be swivel, or rotatable. A swivel caster is movable in any direction, which makes it possible to easily steer the patient handling apparatus 10 in any direction. Thus, when a force is applied to the patient handling apparatus 10, the at least one caster 14 will align with the force, start to spin and transfer the patient handling apparatus 10 in a direction consistent with the applied force.

The present disclosure relates to a transporting means 20 for a patient handling apparatus 10 and to a brake assembly 18 of the transporting means 20. As previously described, FIGS. 2a, 2b and 2c illustrate perspective views of such transporting means 20 and such brake assemblies 18. The brake assembly 18 is coupled to the at least one caster 14 of the transporting means 20 in order to control the movements of the at least one caster 14. When the brake assembly 18 is activated, it may prevent rotation of the wheel of the at least one caster 14. The brake assembly 18 is activated by activating the brake assembly actuator 18a. The brake assembly actuator 18a may have different appearances, as seen in FIGS. 2a, 2b and 2c. The brake assembly 18 is preferably activated when a patient is going to be lifted or lowered by the lifting device 30 of the patient handling apparatus 10. Thereby movement of the patient handling apparatus 10 is prevented while handling the patient. By stopping the patient handling apparatus 10 from moving at such occasions, the risk of injuries, of both the patient and the person operating the patient handling apparatus 10, may be reduced. The risk of the patient handling apparatus 10 suddenly moving in an unexpected direction may be prevented or at least reduced.

As illustrated in FIGS. 2a, 2b and 2c, the at least one caster 14 is movably connected to the patient handling apparatus 10 via a lift base 11 of the patient handling apparatus 10. More specifically, the at least one caster 14 may be coupled to the patient handling apparatus 10 via a lift base plate 11a of the lift base 11. The lift base plate 11a is a relatively thin plate protruding in a rear direction of the patient handling apparatus 10 from the lift base 11. The rear direction of the patient handling apparatus 10 is a direction towards the caregiver, while a front direction is in front of the patient handling apparatus 10, i.e. away from the caregiver.

As previously described, the brake assembly 18 comprises a brake actuator 18a. The brake actuator 18a activates and controls the braking functionality of the brake assembly 18. Depending on how the braking functionality is controlled, it is determined whether the patient handling apparatus 10 is movable or braked in a locked position. The brake actuator 18a may be activated, de-activated and controlled by a person operating the patient handling apparatus 10.

Referencing FIGS. 2a and 2b, the brake actuator 18a may comprise a lever actuation element. The lever actuation element is arranged to cause switching between the operational modes of the caster 14 by means of pivoting of said lever actuation element.

Referencing FIG. 2c, the brake actuator 18a may comprise an actuation switch, e.g. an actuation button. The actuation switch is arranged to cause switching between the operational modes of the caster 14 by means of pressing of the actuation switch.

The brake actuator 18a is mounted to the lift base 11, or to the lift base plate 11a, and connected to the at least one caster 14 via a caster neck 14c of the caster 14 through the lift base 11, or the lift base plate 11a. Preferably, the caster neck 14c is extending through a hole 11b of the lift base 11. The caster neck 14c is illustrated in FIG. 2d, which illustrates the connection and relation between the brake actuator 18a and the caster 14. By connecting the brake actuator 18a with the caster 14 via the caster neck 14c, the brake actuator 18a is located on top of the lift base 11 while the wheel of the caster 14 is located below the lift base 11, or at least below the lift base plate 11a. As the brake actuator 18a is located on top of the lift base 11 and is not mounted directly on top of the caster 14, the brake actuator 18a is accessible to a user operating the patient handling apparatus 10 in a non-swivel area. A non-swivel area is an area that is unaffected by the wheel swivel, i.e. regardless of how the wheels of the caster 14 are orientated, the brake actuator 18a will always be accessible above the lift base 11, or the lift base plate 11a. Thus, the brake actuator 18a will be accessible to the user at all times, regardless of the orientation of the patient handing apparatus 10, or more specifically, regardless of the orientation of the caster 14 of the patient handling apparatus 10.

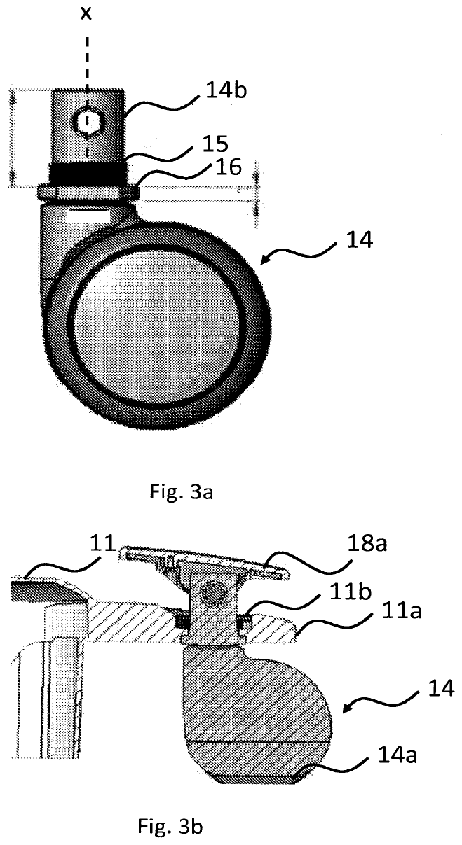

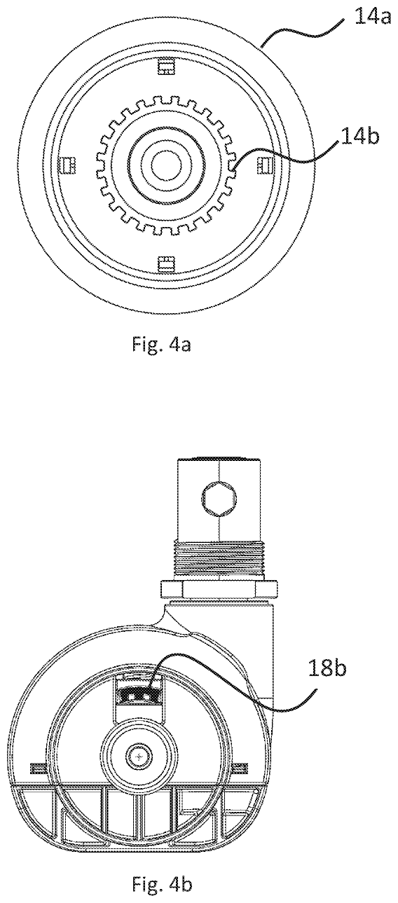

FIG. 3a illustrates a side view of a caster 14 of the transporting means 20. The caster is a rear caster 14. FIG. 3b shows a cross-section view of the rear caster 14 and the brake actuator 18a mounted to the lift base plate 11a. As illustrated in FIGS. 3a and 3b, the rear caster 14 may be movably mounted to the lift base plate 11a by a fastening arrangement 15, 16. The fastening arrangement 15, 16 may comprise, for example, threads 15 provided on the caster neck 14c and a nut 16. The brake actuator 18a is mounted to the other side of the lift base plate 11a. Thus, the wheel of the rear caster 14 is below the lift base plate 11a, while the brake actuator 18a is located on top of the lift base plate 11a, as illustrated in FIG. 3b. The brake actuator 18a may swivel together with the castor 14 such that it may be possible, by looking at the brake actuator 18a, to see at which direction the at least one caster 14 is aligned. For example, if the brake actuator 18a is positioned as illustrated in FIG. 3b, this implies that the caster 14 is aligned in a straight direction with the patient handling apparatus 10. However, in other embodiments, the brake actuator 18a may be connected to the caster 14 and mounted to the lift base plate 11a such that the brake actuator 18a does not swivel together with the caster 14. This may provide a brake actuator 18a that may be easy to activate, or deactivate, as it always will be positioned in the same direction.

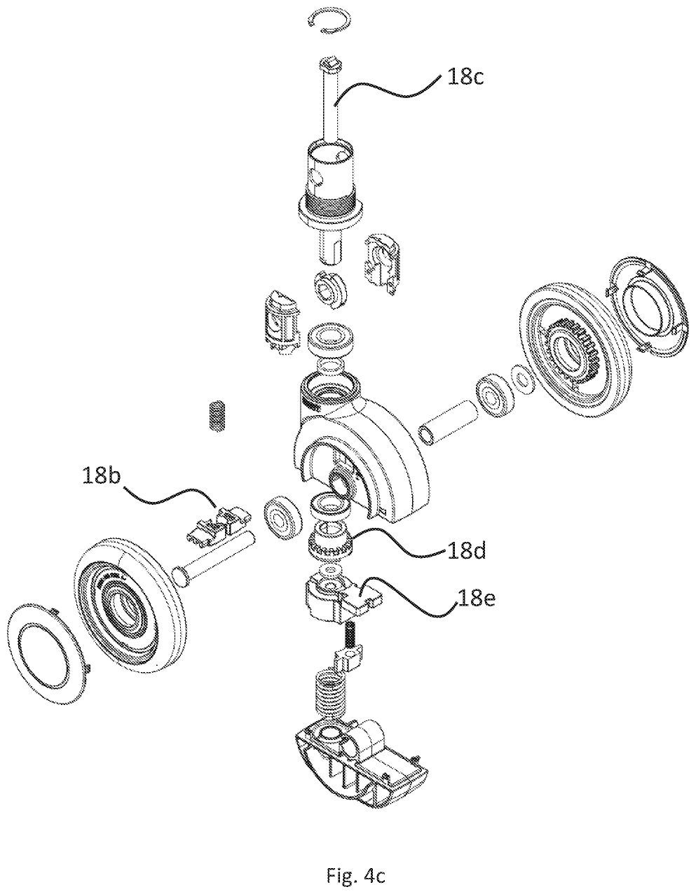

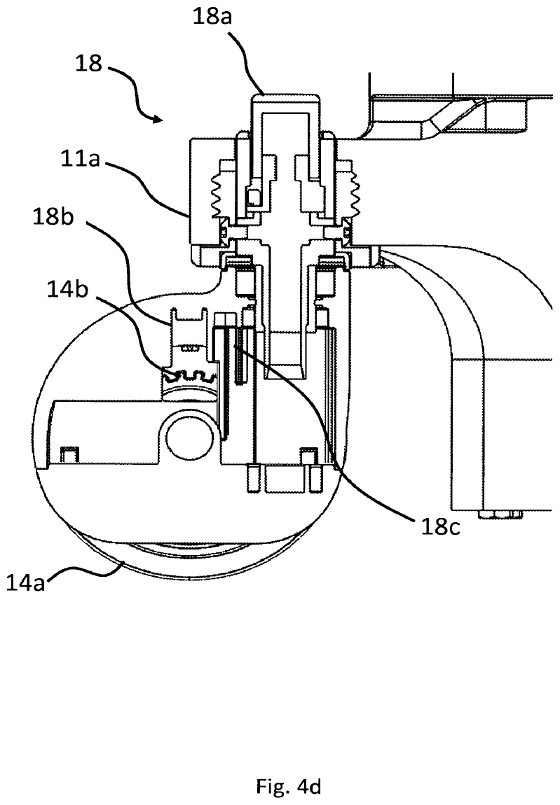

FIG. 4a shows a wheel 14a of the at least one caster 14. It is the wheel 14a of the caster 14 that makes it possible to transport the patient handling apparatus 10. As seen in FIG. 4a, the wheel 14a is provided with teeth 14b on an annular shoulder. These teeth 14b are provided to engage with a brake element 18b of the brake assembly 18. The brake element 18b is illustrated in FIG. 4b. When the brake actuator 18a is activated, the brake element 18b will be pushed downwards towards the teeth 14b of the wheel 14a. The teeth of the brake element 18b will engage with the teeth 14b of the wheel and prevent rotation of the wheel 14a. Thus, the caster 14 will be locked in a fixed position, which will prevent the patient handling apparatus 10 from any movements.

The connection and relation between the caster 14 and the brake assembly 18 according to one embodiment is illustrated in FIG. 4c. As seen in FIG. 4c, the brake assembly 18 may comprise a plunger 18c which may be actuated by the brake actuator 18a. The plunger 18c may affect a teethed coupling 18d, which in turn may activate a brake element activator 18e. Based on the movements of the brake element activator 18e, the brake element 18b may be engaged with, or separated from, the teeth 14b of the wheel 14a.

The connection and relation between the caster 14a and the brake assembly with a brake actuator comprising an actuation switch according to one embodiment is illustrated in FIG. 4d. The plunger 18c is connected to the actuation switch and is actuated by the pressing of the actuation switch. As described with reference to FIG. 4c, the plunger 18c may affect a teethed coupling 18d, which in turn may activate a brake element activator 18e. Based on the movements of the brake element activator 18e, the brake element 18b may be engaged with, or separated from, the teeth 14b of the wheel 14a.

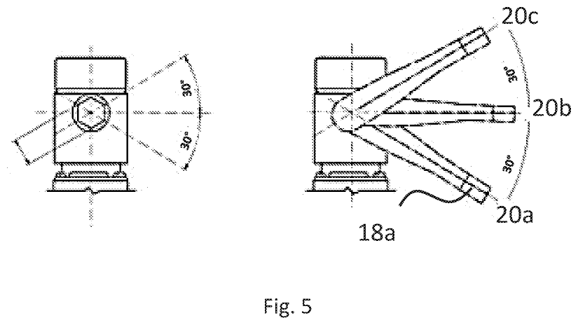

The brake actuator 18a may preferably be operated to control the at least one caster 14 to be in three operating modes. The different modes in which the brake actuator 18a may operate the at least one caster 14 in are illustrated in FIG. 5. The three operating modes are a total lock mode 20a, a non-braking mode 20b and a directional lock mode 20c. The total lock mode 20a locks the caster 14 completely such that the wheels 14a of the caster 14 is prevented from rotating. The non-braking mode 20b, or active mode, releases the brake element 18b from the wheel 14a and allows the wheel 14a to move in any direction, i.e. the wheel 14a may be rotated forwards and backwards, but may additionally also swivel. The directional lock mode 20c allows the wheel 14a of the caster 14 to rotate, but only in a locked direction. Thus, the patient handling apparatus 10 may be moved forwards and backwards in the locked direction, but may not be affected to move in any other direction.

According to some embodiments, the at least one caster 14 may comprise two wheeled casters, or doubled wheeled casters, as illustrated in FIG. 2. By using multiple wheels in tandem on the same wheel axis, the load capacity may be increased while limiting swivel-rotation resistance. Each wheel 14a will have a comparatively narrower ground contact patch than a single wide wheel, which will obtain less resistance to turning in place on the swivel.

The material of the at least one caster 14 according to the present disclosure may comprise polyamide. In some embodiments, the wheel of the at least one caster 14 may comprise polyamide with thermoplastic polyurethane, or TPU, threads. By additionally use TPU threads with the polyamide, the material of the at least one caster 14 may be strengthened.

In some embodiments, the transporting means 20 may comprise at least two casters 13, 14. One of the at least two casters 13 may be provided at the front of the wheeled base of the patient handling apparatus 10. The other of the at least two casters 14 may be provided at the rear end of the wheeled base of the patient handling apparatus. 10. Thus, the transporting means 20 may comprise at least one front caster 13 and at least one rear caster 14. In such embodiments, the at least one rear caster 14 may cooperate with the other at least one front caster 13 of the transporting means 20 to move the patient handling apparatus 10 relative the ground. While the at least one rear caster 14 may preferably be coupled, or movably attached, to the lift base 11 of the patient handling apparatus 10, the front caster 13 may be coupled to at least one leg 12 protruding from the lift base 11. Preferably, the transporting means 20 of patient handling apparatus 10 comprises two front casters 13 and two rear casters 14.

The brake assembly 18 according to the present disclosure will be associated with at least one caster 13, 14 of the patient handling apparatus 10. Preferably, each rear caster 14 of the patient handling apparatus 10 may be provided with a brake assembly 18. In some embodiments, also the front casters 13 of the patient handling apparatuses 10 may be provided with brake assemblies 18.

The present disclosure additionally relates to a patient handling apparatus 10. An example of such patient handling apparatus is illustrated in FIG. 1. The patient handling apparatus 10 comprises the transporting means 20 comprising the brake assembly 18 as described above. The transporting means 20 transports the patient handling apparatus 10 from one location to another location and the brake assembly 18 controls the movements of the transporting means of the patient handling apparatus 10.

The patient handling apparatus 10 further comprises the lift base 11 with a frame 19, a boom 22 and a patient support device. The patient support device may be realised in several different ways and is not illustrated in the figure. The frame 19 extends orthogonally to the lift base 11 of the patient handling apparatus 10. The frame 19 may protrude from a position relatively centered of the lift base 11 of the patient handling apparatus 10. The boom 22 may be movably mounted to the frame 19. The boom 22 may be coupled to the patient support device, which is adapted to support a patient, i.e. support the weight of said patient.

The frame 19, the boom 22 and the patient support device may sometimes collectively be referred to as the lifting device 30. The lifting device 30 may receive the patient and perform the lifting and lowering of the patient out of, and into, the bed, chair or furniture, or can be used for patient ambulation. When a patient has been lifted out of the bed, chair or furniture, the patient may be moved to another location by the patient handling apparatus 10 with the help of the transporting means 20. The transporting means 20 and the lifting device 30 may be connected, or coupled, to each other via the lift base 11 of the patient handling apparatus 10. Alternatively, the transporting means 20 and the lifting device 30 may be connected to each other via at least one leg 12 connected to the lift base 11 of the patient handling apparatus 10.

The lift base 11 of the patient handling apparatus 10 supports the lifting device 30 for lifting, raising and lowering a patient. As illustrated in FIG. 1, the at least one leg 12 may extend from the lift base 11. Preferably, the patient handling apparatus 10 may comprise two legs 12. Each of the two legs 12 may then be coupled to at least one caster 13 of the transporting means 20. By using two legs 12, the width W of the at least one leg 12 may be kept smaller, or narrower, than if only one leg 12 is used. The width W of each of the two legs 12 may be kept narrow without losing the stability of the patient handling apparatus 10. Additionally, by using two narrow legs, the weight of the patient handling apparatus 10 may be smaller than if using one leg 12 with a broader width W.

The patient handling apparatus 10 may further implement an arrangement for linear movement, i.e. raising and lowering of the boom 22 coupled to the patient support device. The patient handling apparatus 10 may comprise a translational arrangement 23. The translational arrangement 23 movably connects the boom 22 and the lift base 11. The translational arrangement 23 is adapted to guide raising and/or lowering of the patient support device relative the lift base 11 in a vertical direction. Thus, the boom 22 may be movable relative to the lift base 11.

The patient support device coupled to the boom 22 is the device of the patient handling apparatus 10 to which the patient is secured when performing the lifting, lowering and transporting of the patient. It may be realised in several different ways and may be chosen in dependence of the health status of the patient and the locations from, and to, the patient is to be transported. In one embodiment, the patient support device may be in the form of a chair support. In such embodiment, the patient support device may be adapted to support a seated patient. Alternatively, the patient support device may be a stretcher. In such embodiment, the patient support device may comprise a substantially planar member. Said substantially planar member is adapted to support a patient, i.e. a patient in a recumbent position.

The patient handling apparatus 10 may further comprise a drive unit adapted to drive the boom 22 relative the frame 19. Thus, the lifting device 30 of the patient handling apparatus 10 may be moved relative the transporting means 20, or ground, both by means of manual operation and by means of the drive unit. In an alternative embodiment, the patient handling apparatus 10 may be solely manually operated and may thus not comprise said drive unit.

In one embodiment, the patient handling apparatus 10 may comprise a control unit and a user interface connected to said control unit. The control unit is connected to the drive unit and configured to control said drive unit. The user interface is configured to receive a control signal based on user input, whereby the control unit is configured to control the drive unit based on said control signal. Thereby, the person handling the patient handling apparatus 10 may be able to control the lifting device 30 by using the user interface.

The invention has been described above in detail with reference to embodiments thereof. However, as is readily understood by those skilled in the art, other embodiments are equally possible within the scope of the present invention, as defined by the appended claims.

1. A brake assembly of a transporting means for a patient handling apparatus, said brake assembly comprising a brake actuator, wherein the brake assembly is adapted to control movements of a wheel of at least one rear caster by activating the brake actuator and wherein said brake actuator is coupled to a caster neck of said at least one rear caster, said caster neck extending through a lift base of the patient handling apparatus such that the brake actuator is located on top of the lift base and the wheel of the at least one rear caster is located below the lift base.

2. The brake assembly according to claim 1, wherein the brake assembly further comprises a brake element adapted to engage with teeth provided on an annular shoulder of the at least one rear caster when the brake actuator is activated.

3. The brake assembly according to claim 1, wherein said brake actuator is adapted to control the at least one rear caster to be in three operating modes, wherein the three operating modes are a total lock mode, a non-braking mode and a directional lock mode.

4. A transporting means for a patient handling apparatus, wherein the transporting means comprises at least one rear caster coupled to a brake assembly, wherein the brake assembly is adapted to control movements of a wheel of the at least one rear caster by activating a brake actuator of the brake assembly and wherein said brake actuator is coupled to a caster neck of said at least one rear caster, said caster neck extending through a lift base of the patient handling apparatus such that the brake actuator is located on top of the lift base and the wheel of the at least one rear caster is located below the lift base.

5. The transporting means according to claim 4, wherein the caster neck of the at least one rear caster extends through a lift base plate of the lift base of the patient handling apparatus such that the brake actuator of the brake assembly is located on top of the lift base plate and the wheel of the at least one rear caster is located below the lift base plate.

6. The transporting means according to any of claim 4, wherein the brake assembly further comprises a brake element and the at least one rear caster is provided with teeth provided on an annular shoulder of the at least one rear caster, wherein the brake element is adapted to engage with the teeth when the brake actuator is activated.

7. The transporting means according to claim 4, wherein said brake actuator is adapted to control the at least one caster to be in three operating modes, wherein the three operating modes are a braking mode, a non-braking mode and a directional lock mode.

8. The transporting means according to claim 4, wherein the transporting means comprises two rear casters and wherein at least one of the two rear casters is coupled to the brake assembly.

9. The transporting means according to claim 8, wherein each of the two rear casters is coupled to the brake assembly.

10. The transporting means according to claim 4, wherein the material of said at least one rear caster comprises polyamide.

11. The transporting means according to claim 4, wherein the at least one rear caster comprises two wheels.

12. The transporting means according to claim 4, wherein said at least one rear caster is a swivel.

13. The transporting means according to claim 4, wherein the at least one rear caster is movably mounted to the lift base by a fastening arrangement.

14. The transporting means according to claim 13, wherein said fastening arrangement comprises threads provided on the caster neck and a nut.

15. The transporting means according to claim 4, wherein said transporting means further comprises at least one front caster.

16. The transporting means according to claim 15, wherein said at least one front caster is adapted to be coupled to at least one leg extending from the lift base of the patient handling apparatus.

17. A patient handling apparatus for handling a patient, wherein the patient handling apparatus comprises a lifting device for lifting, raising and lowering the patient and wherein the lifting device comprises a lift base with a frame, a boom and a patient support device, the patient support device being movable relative the lift base, and wherein the patient handling apparatus further comprises the transporting means according to claim 4 for transporting the patient handling apparatus from one location to another.
